(19) United States
(12) Patent Application Publication
(10) Pub. No.: US 2025/0139793 A1
(43) Pub. Date: May 1, 2025

(54) METHOD FOR CHANGING TARGET SHOOTING CYCLE FOR RECONNAISSANCE OF TARGET AND APPARATUS FOR THE SAME

(71) Applicant: AGENCY FOR DEFENSE DEVELOPMENT, Daejeon (KR)

(72) Inventors: Nam Won AN, Daejeon (KR); Kyung Mee LIM, Daejeon (KR); Byung Gyu CHO, Daejeon (KR); So Young JEONG, Daejeon (KR)

(21) Appl. No.: 18/931,482

(22) Filed: Oct. 30, 2024

(30) Foreign Application Priority Data
Oct. 31, 2023 (KR) 10-2023-0148554

(51) Int. Cl. G06T 7/246; G06T 7/73; G06V 20/40

(52) U.S. Cl. CPC G06T 7/248; G06T 7/74; G06V 20/46; G06T 2207/10016; G06T 2207/30232

(57) ABSTRACT

Provided are systems, devices, methods, and instructions for changing target shooting cycle for reconnaissance of target, including obtaining a first target video and detecting a target included in the first target video through coordinate correction to the first target video, determining whether the target is a previously identified target, when it is determined that the target is the previously identified target, extracting change degrees between the first target video and target videos obtained before obtaining the first target video, and changing a shooting cycle of the target from a first shooting cycle to a second shooting cycle based on the change degrees.

### PRIORITY INFORMATION

This application claims the benefit of Korean Patent Application No. 10-2023-0148554, filed on Oct. 31, 2023, in the Korean Intellectual Property Office, the disclosure of which is incorporated herein by reference in its entirety.

### FIELD OF THE INVENTION

Example embodiments relate to a method for changing a target shooting cycle for reconnaissance of a target and an apparatus for the same.

### DISCUSSION OF THE RELATED ART

A military reconnaissance mission is a mission of shooting a target using reconnaissance assets such as an unmanned air vehicle, a satellite, and a tracking radar and then obtaining information on the target through comparative analysis with previous videos and performing sign detection. Since the number of targets managed in a military unit employing reconnaissance assets may be highly varied depending on circumstances and shooting all targets at every reconnaissance mission is difficult, targets may be selected and shot.

When conducting reconnaissance missions, generally as a shooting cycle is set short, information on the target may be rapidly obtained, but increased mission time due to more targets to be shot may raise various costs for employing reconnaissance assets. Conversely, when a shooting cycle is set long, mission time decreases, but important military information may not be obtained in a timely manner, which leads to a need for establishing a suitable reconnaissance mission based on changes in targets.

### SUMMARY OF THE INVENTION

Accordingly, the embodiments of the present invention are directed to systems, devices, methods, and instructions for changing target shooting cycle for reconnaissance of target that substantially obviates one or more problems due to limitations and disadvantages of the related art.

An aspect provides a method of efficiently generating a mission plan information for reconnaissance of a target. Specifically, another aspect provides a method of changing a target shooting cycle for reconnaissance of a target, related to a method of effectively selecting and scheduling a target for performing surveillance and reconnaissance based on detailed information about the target using a database for integrated target management.

According to an aspect, there is provided a method of changing a target shooting cycle performed by an electronic apparatus, the method including obtaining a first target video and detecting a target included in the first target video through coordinate correction to the first target video, determining whether the target is a previously identified target, when it is determined that the target is the previously identified target, extracting change degrees between the first target video and target videos obtained before obtaining the first target video, and changing a shooting cycle of the target from a first shooting cycle to a second shooting cycle based on the change degrees.

The target videos obtained before obtaining the first target video may include a second target video obtained before obtaining the first target video and a third target video obtained before obtaining the second target video, and the extracting change degrees may include extracting a first change degree between the first target video and the second target video, a second change degree between the first target video and the third target video, and a third change degree between the second target video and the third target video.

The changing may include determining whether at least one of the change degrees exceeds a change degree threshold, and when it is determined that all of the change degrees do not exceed the change degree threshold, changing the shooting cycle of the target from the first shooting cycle to the second shooting cycle, and the second shooting cycle may have a greater value than the first shooting cycle.

The changing the shooting cycle of the target from the first shooting cycle to the second shooting cycle may include determining a shooting cycle increase-decrease coefficient based on a difference between an average of a first change degree between the first target video and a second target video, a second change degree between the first target video and a third target video, and a third change degree between the second target video and the third target video and the change degree threshold and changing the shooting cycle of the target from the first shooting cycle to the second shooting cycle based on the shooting cycle increase-decrease coefficient.

According to an example embodiment, the method may further include determining whether to shoot the target at a second mission time point that is a mission time point after a first mission time point of obtaining the first target video, and the determining may include determining whether to shoot the target at the second mission time point based on a number difference of days between the first mission time point and the second mission time point and the second shooting cycle.

According to an example embodiment, the method may further include, after shooting the target at the second mission time point, when at least one of the change degrees between the first target video and the target videos obtained before obtaining the first target video is greater than a change degree threshold, changing the shooting cycle of the target to a third shooting cycle, and the third shooting cycle may correspond to a shooting cycle of shooting the target at every mission time point.

The changing the shooting cycle of the target may include determining whether at least one of the change degrees exceeds a change degree threshold, and when it is determined that at least one of the change degrees exceeds the change degree threshold, changing the shooting cycle of the target from the first shooting cycle to a third shooting cycle.

According to an example embodiment, the method may further include, when it is determined that the target is a new target, extracting a characteristic of the new target, determining a maximum shooting cycle related to the new target, registering target information of the new target, and determining a shooting cycle of the new target as a third shooting cycle.

According to another aspect, there is also provided an electronic apparatus that performs a method of changing a target shooting cycle, the electronic apparatus including a memory and a processor configured to obtain a first target video and detect a target included in the first target video through coordinate correction to the first target video, determine whether the target is a previously identified target, when it is determined that the target is the previously identified target, extract change degrees between the first target video and target videos obtained before obtaining the first target video, and change a shooting cycle of the target from a first shooting cycle to a second shooting cycle based on the change degrees.

According to example embodiments of the present disclosure, it is possible to flexibly plan a reconnaissance mission based on a recent change degree of a target video through a method of changing a target shooting cycle.

In addition, depending on a recent change degree of a target video through a method according to the present disclosure, for example, when the recent change degree of the target video is slight, it is possible to increase a target shooting cycle rapidly to reduce unnecessary mission time and costs on a corresponding target, and when the recent change degree of the target video is significant, it is possible to decrease a shooting cycle based on various military signs according to a target change. By automatically determining whether to shoot a target when a particular mission is executed based on a target shooting cycle changed depending on a recent movement of the target, it is possible to easily establish a flexible mission plan.

Furthermore, it is possible to plan a suitable reconnaissance mission for a purpose of the reconnaissance mission based on an obtained information volume about a target and an increase in mission time for the reconnaissance mission.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram for illustrating a system of changing a target shooting cycle according to an example embodiment;

FIG. 2 is a block diagram for illustrating a structure of an electronic apparatus changing a target shooting cycle according to an example embodiment;

FIGS. 3A and 3B are diagrams for illustrating in detail a method of changing a target shooting cycle according to an example embodiment;

FIGS. 4A and 4B are diagrams for illustrating a process of determining a change degree of a target video in a method of changing a target shooting cycle according to an example embodiment; and

FIG. 5 is a diagram for illustrating a process of establishing a target shooting plan based on a changed shooting cycle in a method of changing a target shooting cycle according to an example embodiment.

### DETAILED DESCRIPTION

Terms used in example embodiments are selected from currently widely used general terms when possible while considering the functions in the present disclosure. However, the terms may vary depending on the intention of a person skilled in the art, precedents, the emergence of new technology, and the like. Further, in certain cases, there are also terms arbitrarily selected by the applicant, and in these cases, the meaning will be described in detail in the corresponding descriptions. Therefore, the terms used in the present disclosure are not to be construed simply as its designation but based on the meaning of the term and the overall context of the present disclosure.

Throughout the specification, when a part is described as “comprising or including” a component, it does not exclude another component but may further include another component unless otherwise stated.

The expression “at least one of a, b, and c” described throughout the specification may include “a alone,” “b alone,” “c alone,” “a and b,” “a and c,” “b and c,” or “all of a, b, and c.”

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication apparatus ensuring portability and mobility and include (but is not limited to) any type of handheld wireless communication apparatus, for example, a tablet PC, a smartphone, a communication-based terminal such as international mobile telecommunication (IMT), code division multiple access (CDMA), W-code division multiple access (W-CDMA), long term evolution (LTE), or the like.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

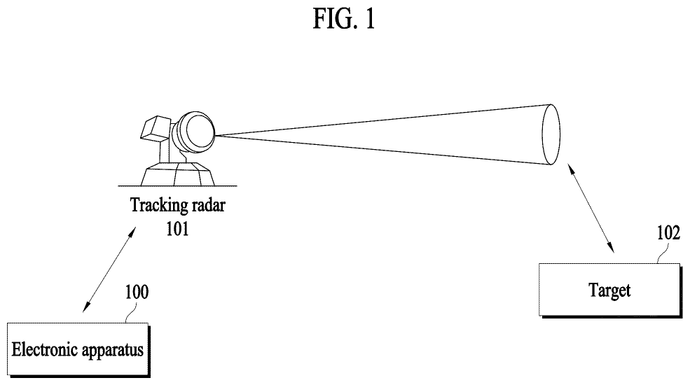

FIG. 1 is a diagram for illustrating a system of changing a target shooting cycle according to an example embodiment.

When a military reconnaissance mission is conducted, movements of a target to be an object of reconnaissance may be periodically observed, and a shooting plan may be suitably established at a reconnaissance mission time point. For example, as a target shooting cycle is set short in conducting a military reconnaissance mission, information on a target may be rapidly obtained, but mission time may increase due to more targets to be shot in conducting a mission once and human and administrative costs for employing reconnaissance assets may rise. Conversely, when a target shooting cycle is set long, mission time for conducting a mission once may decrease, but important military information may not be obtained in a timely manner as a speed of obtaining information on a target slows. It may be ideal that a large volume of information is obtained for a short mission time, but these two are in a trade-off relationship based on a shooting cycle, and accordingly, a suitable target shooting cycle may be set and adjusted based thereon.

Referring to FIG. 1, in a system of changing a target shooting cycle according to an example embodiment, a tracking radar 101 may detect a target 102, generate a signal for tracking the target 102, and radiate the signal to the target 102. Then, the tracking radar 101 may receive a reflected signal from the target 102 and obtain various video histories based on time of a video including the target 102.

The target 102 may be a target to be tracked and shot by the tracking radar 101. The target 102 may have various forms and sizes, which may change depending on a reconnaissance mission performed by the tracking radar 101. The target 102 may be identified and tracked by the tracking radar 101 and may be a new target that is newly detected based on the purpose and history of a military reconnaissance mission or may also be a previously identified target that is previously detected already.

An electronic apparatus 100 may perform a method of changing a shooting cycle of the target 102 according to an example embodiment and may set a shooting plan based on a mission time point regarding whether the tracking radar 101 shoots the target 102.

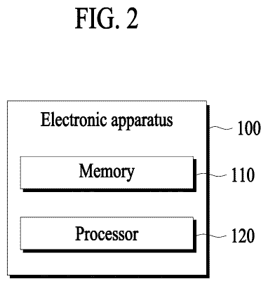

FIG. 2 is a block diagram for illustrating a structure of an electronic apparatus changing a target shooting cycle according to an example embodiment.

Referring to FIG. 2, the electronic apparatus 100 may include a memory 110 and a processor 120. In the electronic apparatus 100 illustrated in FIG. 2, elements related to the example embodiments are illustrated. Therefore, it is apparent to those of ordinary skill in the art that other general-purpose elements in addition to the elements illustrated in FIG. 2 may be further included in the electronic apparatus 100.

The memory 110 is hardware for storing various data processed in the electronic apparatus 100, and the memory 110 may store data processed in the electronic apparatus 100 and data to be processed therein. In addition, the memory 110 may store applications, drivers, or the like to be operated by the electronic apparatus 100. The memory 110 may include random access memory (RAM), such as dynamic random access memory (DRAM) and static random access memory (SRAM), read-only memory (ROM), electrically erasable programmable read-only memory (EEPROM), CD-ROM, Blu-ray or other optical disk storage, hard disk drive (HDD), solid-state drive (SSD) or flash memory.

The processor 120 controls the electronic apparatus 100 in general by executing programs related to algorithms stored in the memory 110 within the electronic apparatus 100. The processor 120 may be implemented as a central processing unit (CPU), a graphics processing unit (GPU), or an application processor (AP) provided within the electronic apparatus 100 but is not limited thereto.

The processor 120 may control the electronic apparatus 100 to perform a method of changing a target shooting cycle so that the electronic apparatus 100 obtains a first target video and detects a target included in the first target video through coordinate correction to the first target video, determines whether the target is a previously identified target, when it is determined that the target is the previously identified target, extracts change degrees between the first target video and target videos obtained before obtaining the first target video, and changes a shooting cycle of the target from a first shooting cycle to a second shooting cycle based on the change degrees.

For example, when the processor 120 extracts change degrees between the first target video and target videos obtained before obtaining the first target video, the target videos obtained before obtaining the first target video may include a second target video obtained before obtaining the first target video and a third target video obtained before obtaining the second target video, and the processor 120 may extract a first change degree between the first target video and the second target video, a second change degree between the first target video and the third target video, and a third change degree between the second target video and the third target video.

For example, the processor 120 may determine whether at least one of the change degrees exceeds a change degree threshold, and when it is determined that all of the change degrees do not exceed the change degree threshold, may change the shooting cycle of the target from the first shooting cycle to the second shooting cycle, and in this case, the second shooting cycle may have a greater value than the first shooting cycle.

For example, the processor 120 may determine a shooting cycle increase-decrease coefficient based on a difference between an average of a first change degree between the first target video and a second target video, a second change degree between the first target video and a third target video, and a third change degree between the second target video and the third target video and the change degree threshold and change the shooting cycle of the target from the first shooting cycle to the second shooting cycle based on the shooting cycle increase-decrease coefficient.

For example, the processor 120 may determine whether to shoot the target at a second mission time point that is a mission time point after a first mission time point of obtaining the first target video, and in this case, may determine whether to shoot the target at the second mission time point based on a number difference of days between the first mission time point and the second mission time point and the second shooting cycle.

For example, the processor 120 may, after shooting the target at the second mission time point, when at least one of the change degrees between the first target video and the target videos obtained before obtaining the first target video is greater than a change degree threshold, change the shooting cycle of the target to a third shooting cycle, and in this case, the third shooting cycle may correspond to a shooting cycle of shooting the target at every mission time point.

For example, the processor 120 may determine whether at least one of the change degrees exceeds a change degree threshold, and when it is determined that at least one of the change degrees exceeds the change degree threshold, change the shooting cycle of the target from the first shooting cycle to a third shooting cycle.

For example, the processor 120 may, when it is determined that the target is a new target, extract a characteristic of the new target, determine a maximum shooting cycle related to the new target, register target information of the new target, and determine a shooting cycle of the new target as a third shooting cycle. In this case, the maximum shooting cycle related to the new target may refer to a greatest shooting cycle within a settable range of target shooting cycles based on a characteristic of the new target and the purpose of a military reconnaissance mission.

Hereinafter, examples of a method of changing a target shooting cycle performed by the electronic apparatus 100 according to example embodiments are described.

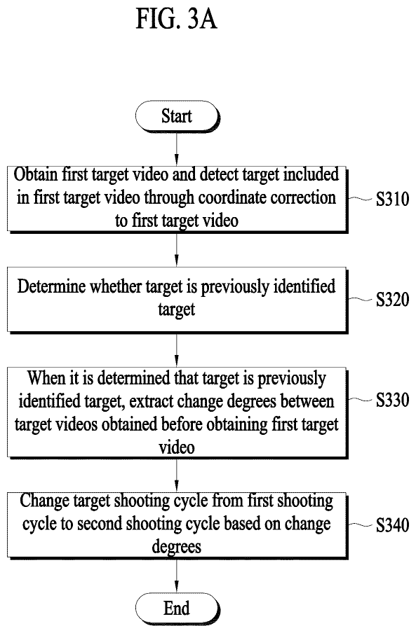

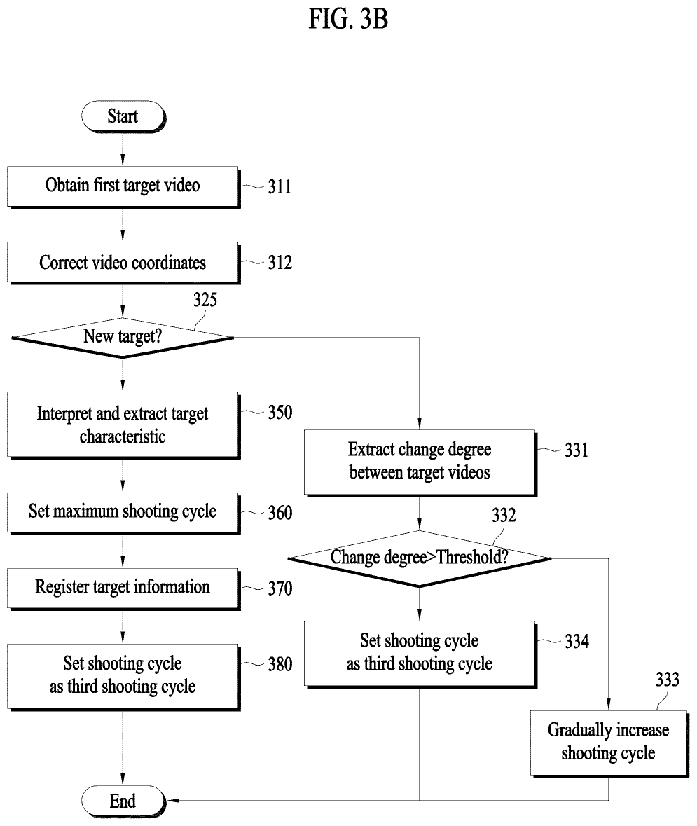

FIGS. 3A and 3B are diagrams for illustrating in detail a method of changing a target shooting cycle according to an example embodiment.

Referring to FIG. 3A, in operation S310, the electronic apparatus 100 according to an example embodiment may obtain a first target video and detect a target included in the first target video through coordinate correction to the first target video.

In operation S320, the electronic apparatus 100 according to an example embodiment may determine whether the target is a previously identified target. When it is determined that the target is a new target, the electronic apparatus 100 may extract a characteristic of the new target, determine a maximum shooting cycle related to the new target, register target information of the new target, and determine a shooting cycle of the new target as a third shooting cycle. In this case, the third shooting cycle may correspond to a shooting cycle of shooting the new target at every mission time point, and for example, may be 1 day that corresponds to a shooting cycle of shooting the new target by a unit of one day when a mission is conducted once a day and mission time points are first day corresponding to d=1 and second day corresponding to d=2. The electronic apparatus 100 may shoot the new target at every mission time point and obtain as much information on the new target as possible within a mission period as short as possible.

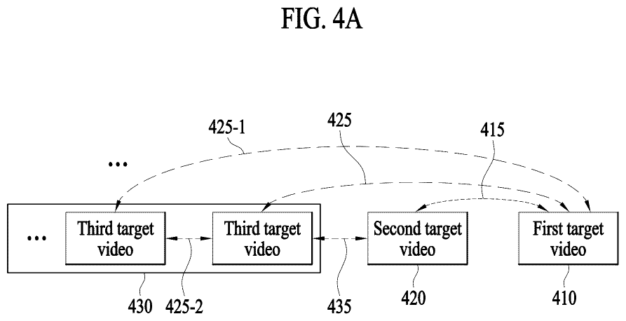

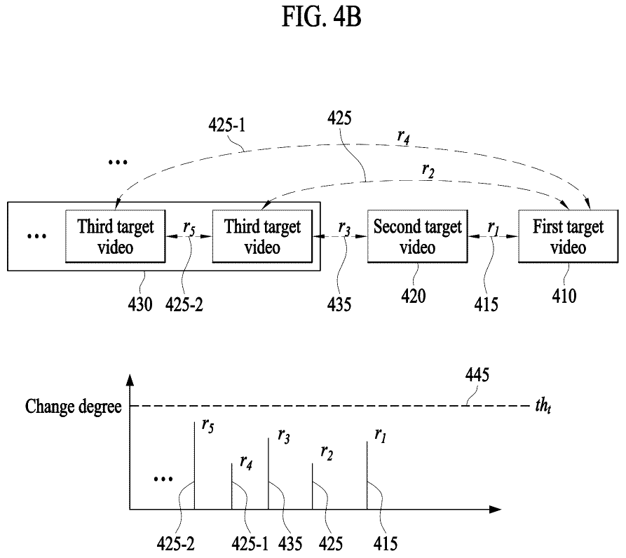

In operation S330, the electronic apparatus 100 according to an example embodiment may, when it is determined that the target is the previously identified target, extract change degrees between target videos obtained before obtaining the first target video. In this case, the target videos obtained before obtaining the first target video may include a second target video obtained before obtaining the first target video and a third target video obtained before obtaining the second target video. The extracting change degrees according to an example embodiment may include extracting a first change degree between the first target video and the second target video, a second change degree between the first target video and the third target video, and a third change degree between the second target video and the third target video. The electronic apparatus 100 may determine that a sharp change occurs in the target by extracting the first change degree, may determine that a gradual change occurs in the target so close observation is required by extracting the second change degree, and may determine that a sharp change occurs recently and another sharp change may occur soon so observation is required for a predetermined period by extracting the third change degree. This is described below in detail with reference to FIG. 4A.

In operation S340, the electronic apparatus 100 according to an example embodiment may change a shooting cycle of the target from a first shooting cycle to a second shooting cycle based on the change degrees. In this case, the first shooting cycle may correspond to a shooting cycle set on the corresponding target before the electronic apparatus 100 changes the shooting cycle, and the second shooting cycle may correspond to a shooting cycle after the electronic apparatus 100 changes the shooting cycle.

When changing the shooting cycle, the electronic apparatus 100 may determine whether at least one of the change degrees exceeds a change degree threshold, and when it is determined that all of the change degrees do not exceed the change degree threshold, change the shooting cycle of the target from the first shooting cycle to the second shooting cycle. In this case, the second shooting cycle may have a greater value than the first shooting cycle. This is to, when all of the change degrees between the target videos do not exceed the change degree threshold, gradually increase the shooting cycle of the target in order to prevent an unnecessary waste of resources by determining that an urgent change is not present in the short term then since an urgent change is not present recently in the corresponding target.

When changing the shooting cycle of the target from the first shooting cycle to the second shooting cycle, the electronic apparatus 100 may determine a shooting cycle increase-decrease coefficient based on a difference between an average of a first change degree between the first target video and a second target video, a second change degree between the first target video and a third target video, and a third change degree between the second target video and the third target video and the change degree threshold and change the shooting cycle of the target from the first shooting cycle to the second shooting cycle based on the shooting cycle increase-decrease coefficient. In this case, the shooting cycle increase-decrease coefficient may be a value determining a change amount between the second shooting cycle and the first shooting cycle when changing the shooting cycle of the target from the first shooting cycle to the second shooting cycle, based on a difference between the change degree threshold and the change degrees between the target videos. This is to increase fast the shooting cycle of the target since a greater difference between the first to third change degrees and the change degree threshold indicates a fewer change in the target and to conservatively increase slowly the shooting cycle of the target since a smaller difference between the first to third change degrees and the change degree threshold indicates a greater change in the target. This is described below in detail with reference to FIG. 4B.

When changing the shooting cycle, the electronic apparatus 100 may determine whether at least one of the change degrees exceeds a change degree threshold, and when it is determined that at least one of the change degrees exceeds the change degree threshold, decrease the shooting cycle of the target from the first shooting cycle to a third shooting cycle. In this case, the third shooting cycle may correspond to a shooting cycle of shooting the new target at every mission time point, and for example, may be 1 day that corresponds to a shooting cycle of shooting the new target by a unit of one day when a mission is conducted once a day and mission time points are first day corresponding to d=1 and second day corresponding to d=2.

Referring to FIG. 3B, the electronic apparatus 100 according to an example embodiment may obtain (operation 311) a target video shot by a reconnaissance asset through the tracking radar 101. After obtaining (operation 311) the target video, the electronic apparatus 100 may correct geographic coordinates such as latitude and longitude that are mapped by each pixel of the video by correcting (operation 312) video coordinates in order to obtain a precise coordinate to be utilized for identifying a new target or comparing videos. In this case, to correct geographic coordinates when correcting (operation 312) the video coordinates, for example, ground control point (GCP)-based geometric correction technology may be used, which sets a reference point aware of a precise geographic coordinate within a video and then offsets video distortion based thereon to correct coordinates. After correcting (operation 312) the video coordinates, the electronic apparatus 100 may obtain a target coordinate in the video and then compare the target coordinate with existing target information and identify (operation 325) whether a detected target is a new target or a previously identified target.

In an example embodiment, when the identified (operation 325) target t is a previously identified target, a change degree of the target may be extracted (operation 331) by comparing target videos in which the target t is shot for recent kₜ days. In this case, kₜ may be a parameter determined through various factors, such as available computer resources, whether or not to be real-time and real-time degree, target characteristics and circumstances, and assigned to a system, and kₜ may be set and utilized based on other criteria such as the number of videos as well as the number of days of shooting a video for comparison, but example embodiments of the present disclosure are not limited to the mentioned cases. For extracting (operation 331) the change degree of the target, a method of comparing change degrees by each pixel between target videos and a method of comparing change degrees by each object may be used, and in addition, a method of utilizing video registration may be used. The electronic apparatus 100 according to an example embodiment may extract the change degree of the target as a 0 to 100 percent (%) value by utilizing existing change detection and measurement techniques.

The electronic apparatus 100 according to an example embodiment may compare (operation 332) the extracted change degree with a change degree threshold and change a shooting cycle depending on a result. In this case, the change degree threshold is a criterion for determining whether the change degree of the target is a meaningful change in a military aspect and may be a system parameter that is determined through modeling or experiment based on data about a predetermined target group handled in a system and then inputted to the system.

The electronic apparatus 100 may compare (operation 332) the extracted change degree with the change degree threshold and, when the extracted change degree is not greater than the change degree threshold, gradually increase and change (operation 333) the shooting cycle.

The electronic apparatus 100 may compare (operation 332) the extracted change degree with the change degree threshold and, when the extracted change degree is greater than the change degree threshold, change (operation 334) the shooting cycle to a minimum.

In an example embodiment, when the identified (operation 325) target t is a new target, the electronic apparatus 100 may interpret the new target and extract (operation 350) a characteristic of the new target, determine (operation 360) a maximum shooting cycle suitable to the characteristic of the target based on military organizational guidelines, and register (operation 370) target information. The shooting cycle of the target is a value determining how often to shoot the target based on the number of mission days, and the maximum shooting cycle may indicate a maximum shooting cycle that may be determined as a shooting cycle of the corresponding new target based on the characteristics of the reconnaissance mission and the new target. In other words, the electronic apparatus 100 may determine the maximum shooting cycle to define a lower bound of the speed of obtaining information without harming reconnaissance effectiveness based on the characteristic of the new target. The electronic apparatus 100 may set (operation 380) the shooting cycle of the new target to a minimum shooting cycle and change the shooting cycle of the target in order to collect as much information on the new target as possible in the short term.

FIGS. 4A and 4B are diagrams for illustrating a process of determining a change degree of a target video in a method of changing a target shooting cycle according to an example embodiment.

Referring to FIG. 4A, the electronic apparatus 100 according to an example embodiment may extract change degrees between a second target video 420 obtained before obtaining a first target video 410 and third target videos obtained before obtaining the second target video in order to extract valid target change degrees from a video within kₜ-window.

The electronic apparatus 100 according to an example embodiment may extract a first change degree 415 between the first target video 410 and the second target video 420. For example, when the first change degree 415 exceeds a change degree threshold may indicate that a sharp change occurs in a target so a military sign is present and a rapid additional information collection is required.

The electronic apparatus 100 according to an example embodiment may extract a second change degree 425 between the first target video 410 and a third target video 430 obtained before obtaining the second target video 420. For example, when the second change degree 425 exceeds the change degree threshold may indicate that a large change gradually occurs in a target within kₜ-window so a military sign is present or observation is required.

The electronic apparatus 100 according to an example embodiment may extract a third change degree 435 between the second target video 420 and the third target video 430 which are adjacent videos in an order of shooting. For example, when the third change degree 435 exceeds the change degree threshold may indicate that a sharp change occurs in a target within kₜ-window so another sharp change may occur soon and observation is required for a predetermined period.

In addition, the electronic apparatus 100 may also extract a change degree 425-1 between the first target video and a target video obtained before the third target video and a change degree 425-2 between the third target video and a video obtained before the third target video in addition to the mentioned first change degree 415, the second change degree 425, and the third change degree 435 while determining the change degree of the target and compare those with the change degree threshold to determine whether to exceed, which may be used in a process of changing a shooting cycle of a target to be described below with reference to FIG. 4B.

In an example embodiment, when it is determined that at least one of the first change degree 415, the second change degree 425, and the third change degree 435 obtained by the electronic apparatus 100 exceeds the change degree threshold, the electronic apparatus 100 may determine the shooting cycle as a third shooting cycle. In this case, the third shooting cycle may correspond to a shooting cycle of shooting the corresponding target at every mission time point. The electronic apparatus 100 may determine the shooting cycle as the third shooting cycle when it is determined that at least one of the change degrees exceeds the change degree threshold in order to obtain as much information on the corresponding target as possible within a short period.

In an example embodiment, when it is determined that at least one of the first change degree 415, the second change degree 425, and the third change degree 435 obtained by the electronic apparatus 100 does not exceed the change degree threshold, the electronic apparatus 100 may determine that a large change is not present in the corresponding target in the short term and gradually increase the shooting cycle.

In an example embodiment, the electronic apparatus 100 may store a value of the first change degree 415 corresponding to a latest change degree of the target video based on time instead of extracting the second change degree 425 and the third change degree 435 and continually utilize the value as the third change degree 435 or the change degree 425-2 between videos obtained before the third target video when extracting change degrees of new videos later.

Referring to FIG. 4B, the electronic apparatus 100 according to an example embodiment may determine whether at least one of the change degrees 415, 425, and 435 mentioned in FIG. 4A exceeds a change degree threshold 445 and, when it is determined that all of the change degrees do not exceed the change degree threshold 445, may change a shooting cycle of a target from a first shooting cycle to a second shooting cycle. In this case, the second shooting cycle may have a greater value than the first shooting cycle. When changing the shooting cycle of the target from the first shooting cycle to the second shooting cycle, the electronic apparatus 100 may determine a shooting cycle increase-decrease coefficient based on a difference between an average of the first change degree 415 between the first target video 410 and the second target video 420, the second change degree 425 between the first target video 410 and the third target video 430, and the third change degree 435 between the second target video 420 and the third target video 430 and the change degree threshold 445 and change the shooting cycle of the target from the first shooting cycle to the second shooting cycle based on the shooting cycle increase-decrease coefficient. FIG. 4B illustrates that the change degree 425-1 between the first target video and a target video obtained before the third target video and the change degree 425-2 between the third target video and a video obtained before the third target video may also be extracted and used while changing a shooting cycle in addition to the mentioned first change degree 415, the second change degree 425, and the third change degree 435, but example embodiments of the present disclosure are not limited to particular cases, and a process of changing a shooting cycle of a target from the first shooting cycle to the second shooting cycle using the first change degree 415, the second change degree 425, and the third change degree 435 alone is described below.

The electronic apparatus 100 according to an example embodiment may obtain an average value C̅ₜ of differences between the first change degree 415, the second change degree 425, and the third change degree 435 and the change degree threshold 445, and based thereon, determine a shooting cycle increase-decrease coefficient. For example, the average value c̅ₜ of differences between the first change degree 415, the second change degree 425, and the third change degree 435 and the change degree threshold may be defined as in the following equation 1.

$${\overline{c}}_{t} = {\sum }_{i = 1}^{3} ( {th}_{t} - {r}_{i} ) / 3 \qquad [ Equation 1 ]$$

In this case, thₜ may indicate the change degree threshold 445, and r₁ to r₃ may indicate the first change degree 415, the second change degree 425, and the third change degree 435 respectively. The electronic apparatus 100 may determine the shooting cycle increase-decrease coefficient based on the average value c̅ₜ of differences between the first change degree 415, the second change degree 425, and the third change degree 435 and the change degree threshold 445. For example, the shooting cycle increase-decrease coefficient may be determined as in the following equation 2.

$${a}_{t} = {a}_{t} + \frac{{\overline{c}}_{t}}{{th}_{t}} \qquad [ Equation 2 ]$$

In this case, aₜ may indicate the shooting cycle increase-decrease coefficient, and the shooting cycle increase-decrease coefficient may be a value determining a change amount between the second shooting cycle and the first shooting cycle when changing the shooting cycle of the target from the first shooting cycle to the second shooting cycle, based on a difference between the change degree threshold and the change degrees between the target videos. For example, an initial value of the shooting cycle increase-decrease coefficient aₜ may be set to 0, and for example, a value of aₜ may increase at every shooting cycle by a value of dividing the average value c̅ₜ of differences between the first change degree 415, the second change degree 425, and the third change degree 435 and the change degree threshold 445 as in equation 2 by the change degree threshold 445. In this case, thₜ may indicate the change degree threshold 445. A changed shooting cycle pₜ obtained based on aₜ by the electronic apparatus 100 may be defined as in the following equation 3.

$${p}_{t} = min ( 1 + ⌊ {a}_{t} ⌋ , {p}_{t}^{max} ) \qquad [ Equation 3 ]$$

In this case, pₜ may indicate the changed shooting cycle, and └aₜ┘ may indicate a largest natural number among natural numbers less than or equal to the shooting cycle increase-decrease coefficient aₜ, and pₜ^{max} may indicate a maximum shooting cycle of a corresponding target.

For example, as degrees by which the first change degree 415, the second change degree 425, and the third change degree 435 between videos within kₜ-window may not reach the change degree threshold 445 are greater, the average value c̅ₜ of differences between the first change degree 415, the second change degree 425, and the third change degree 435 and the change degree threshold 445 is greater, and thus, the shooting cycle increase-decrease coefficient aₜ may increase relatively fast and accordingly pₜ may also increase relatively fast. When change degrees of target videos are slight, the electronic apparatus 100 may determine an increased amount of a shooting cycle to be steep through the shooting cycle increase-decrease coefficient aₜ, decrease the number of times of shooting a corresponding target within an identical time, and minimize a waste of resources.

Conversely, even though the first change degree 415, the second change degree 425, and the third change degree 435 do not exceed the change degree threshold 445, c̅ₜ is smaller when an average value of these change degrees is close to the change degree threshold 445, and thus, the shooting cycle increase-decrease coefficient aₜ may increase relatively slowly, and accordingly, pₜ may also increase relatively slowly. When a change degree of target videos is close to a change degree threshold although not exceeding the change degree threshold, a sharp change may occur soon in a corresponding target, and thus the electronic apparatus 100 may conservatively determine an increased amount of a shooting cycle of the target to be slow through the shooting cycle increase-decrease coefficient aₜ, increase the number of times of shooting the corresponding target within an identical time, and maximize a speed of obtaining information.

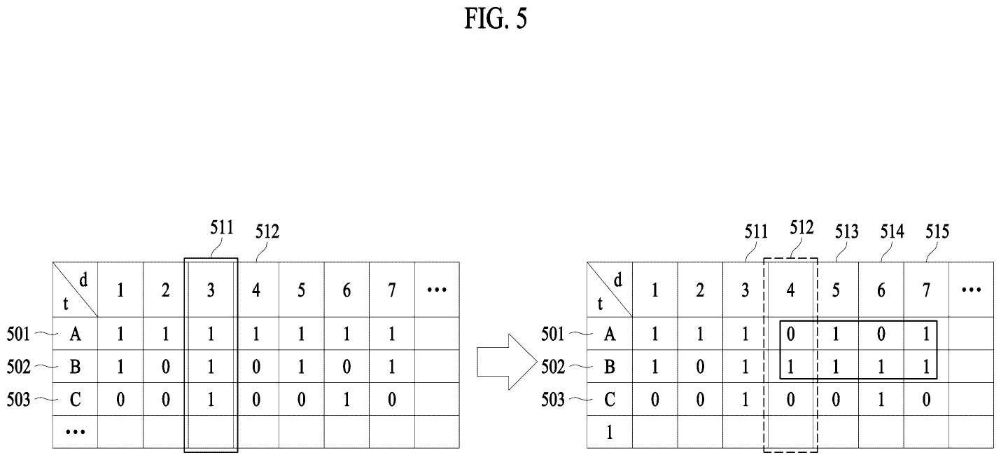

FIG. 5 is a diagram for illustrating a process of establishing a target shooting plan based on a changed shooting cycle in a method of changing a target shooting cycle according to an example embodiment.

The electronic apparatus 100 according to an example embodiment may determine whether to shoot a target at a second mission time point that is a mission time point after a first mission time point of obtaining the first target video. In this case, the electronic apparatus 100 may determine whether to shoot the target at the second mission time point based on a number difference of days between the first mission time point and the second mission time point and the second shooting cycle. For example, when mission time point d and target t are given as input, a function b(d, t) indicating whether to shoot target t may be determined by the following equation 4 as an example.

$$b ( d , t ) = ∼ sgn ( mod ( d - {b}_{t} , {p}_{t} ) ) \qquad [ Equation 4 ]$$

In this case, d may indicate a second mission time point for determining whether to shoot corresponding target t, pₜ may indicate a changed second shooting cycle, and bₜ may indicate a first mission time point at which shooting target t is conducted. For example, the first mission time point at which shooting target t is conducted may be a value of d when pₜ is changed or when shooting t is delayed and then succeeds. For example, when shooting target t that conducts a mission is performed and pₜ is changed (for example, changed from 1 to 2) when d is 10, bₜ is 10. For another example, when shooting t is not performed and delayed when d is 10 and shooting succeeds when d is 13, bₜ is 13. When determining whether to shoot a target according to a shooting cycle through the modulo operation, bₜ may perform a role as a reference value for correction so that the shooting cycle does not become irregular due to shooting whose shooting cycle is changed or delayed. When bₜ is determined, the electronic apparatus 100 may perform the modulo operation on the number difference d−bₜ of days between the first mission time point and the second mission time point through the second shooting cycle pₜ. The electronic apparatus 100 may return 1 or 0 as a value of the function b(d,t) through signum and bitwise complement operation (˜) as in equation 4 and determine whether to shoot. For example, the electronic apparatus 100 may perform shooting target t at mission time point d according to the changed second shooting cycle when b(d,t) is 1 and may not perform shooting when being 0.

Referring to FIG. 5, example embodiments in which the electronic apparatus 100 according to an example embodiment plans whether to shoot a target by each mission based on b(d,t) may be identified. For example, a target to be shot at a mission time point 511 in which d equals 3 may be a target (for example, A target 501, B target 502, and C target 503) corresponding to a cell in which a value is calculated to 1 in the fourth column of the table, in other words, when d equals 3. When collecting these targets, a list of targets to be shot at the mission time point 511 in which d equals 3 may be generated. The electronic apparatus 100 may change the shooting cycle through operations described in FIGS. 3A and 3B based on a shot target video when conducting a mission is completed at the mission time point 511 in which d equals 3. For example, at a mission time point 512 in which d equals 4, shooting cycles of A target 501 and B target 502 are changed, and shooting A target 501 may be excluded at the mission time point 512 in which d equals 4 and B target 502 may be included.

In an example embodiment, the electronic apparatus 100 may not perform shooting due to mission cancellation, obstruction of terrain features, equipment failure, or the like. For example, when target t may not be shot at mission time point d, the electronic apparatus 100 may manage separately a shooting plan regarding target t and have corresponding target t included in a shooting target list of the number of following mission days (d+1, d+2, . . . ). The electronic apparatus 100 may set bₜ to the corresponding number of mission days as described above when shooting succeeds at any time point among the number of following mission days (d+1, d+2, . . . ). For example, when the number of mission days is renewed in a 1-year cycle, mission time point d may have a daily mission unit and be a value of 1 day to 365 days, and the mission time point may have a range changed depending on system implementation and may also be defined as an hourly mission unit, a mission number, or the number of times of mission rather than the daily mission unit.

The electronic apparatus 100 according to an example embodiment may, after shooting the target at the second mission time point, when at least one of the change degrees between the first target video and the target videos obtained before obtaining the first target video is greater than a change degree threshold, change the shooting cycle of the target to a third shooting cycle. In this case, the third shooting cycle may correspond to a shooting cycle of shooting the target at every mission time point. In addition, the electronic apparatus may, when a change degree exceeding the change degree threshold is not present among the change degrees between the first target video and the target videos obtained before obtaining the first target video, change the shooting cycle increase-decrease coefficient as in equation 3 described above. For example, the electronic apparatus 100 may determine the shooting cycle increase-decrease coefficient and the shooting cycle as in equation 5 after shooting the target at the second mission time point.

$${a}_{t} = \{ \begin{matrix}0 , & if ∃ r \geq {th}_{t} for r ∈ {C}_{t} \\ {a}_{t} + \frac{{\overline{c}}_{t}}{{th}_{t}} , & otherwise\end{matrix} \qquad [ Equation 5 ]$$

In this case, aₜ may indicate the shooting cycle increase-decrease coefficient. In this case, Cₜ may indicate a set of change degrees extracted from the video history of t through the method of FIG. 4B, and r may be one of the change degrees included in Cₜ.

For example, when the first change degree 415, the second change degree 425, and the third change degree 435 of A target 501 may not reach the change degree threshold 445 and the average value c̅ₜ of differences between the first change degree 415, the second change degree 425, and the third change degree 435 and the change degree threshold 445 is large, the electronic apparatus 100 may increase the shooting cycle increase-decrease coefficient aₜ relatively fast. Accordingly, the shooting cycle may increase, and the shooting cycle before the mission time point 511 may be 1 day, but the shooting cycle may increase to 2 days from the mission time point 512 after shooting at the mission time point 511.

For example, when at least one of the first change degree 415, the second change degree 425, and the third change degree 435 of B target 502 is greater than the change degree threshold 445, the electronic apparatus 100 may determine the shooting cycle increase-decrease coefficient aₜ as 0, and accordingly, may change the shooting cycle to the third shooting cycle (for example, 1 day). In other words, the shooting cycle of B target 502 before the mission time point 511 may be 2 days, but the electronic apparatus 100 may decrease the shooting cycle to 1 day from the mission time point 512 after shooting at the mission time point 511.

For example, when the first change degree 415, the second change degree 425, and the third change degree 435 of C target 503 may not reach the change degree threshold 445 and the shooting cycle increase-decrease coefficient aₜ is not great enough to change the shooting cycle of C target 503 by equation 3 and equation 4, the the electronic apparatus 100 may maintain the shooting cycle of 3 days of C target 503 before the mission time point 511 as 3 days at the mission time point 512 after shooting at the mission time point 511 and gradually change the shooting cycle of C target 503 from a following mission time point including a following mission time point 513 and a mission time point 514.

The electronic apparatus according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic, and/or look-up table, that may execute various functions by the control of one or more microprocessors or other control devices. Similarly to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical configurations. The terms may include the meaning of a series of routines of software in association with a processor or the like.

It will be apparent to those skilled in the art that various modifications and variations can be made in the systems, devices, methods, and instructions for changing target shooting cycle for reconnaissance of target of the present invention without departing from the spirit or scope of the invention. Thus, it is intended that the present invention cover the modifications and variations of this invention provided they come within the scope of the appended claims and their equivalents.

What is claimed is:

1. A method of changing a target shooting cycle performed by an electronic apparatus, the method comprising:
obtaining a first target video and detecting a target included in the first target video through coordinate correction to the first target video;
determining whether the target is a previously identified target;
when it is determined that the target is the previously identified target, extracting change degrees between the first target video and target videos obtained before obtaining the first target video; and
changing a shooting cycle of the target from a first shooting cycle to a second shooting cycle based on the change degrees.

2. The method of claim 1, wherein the target videos obtained before obtaining the first target video includes a second target video obtained before obtaining the first target video and a third target video obtained before obtaining the second target video, and
wherein the extracting change degrees includes extracting a first change degree between the first target video and the second target video, a second change degree between the first target video and the third target video, and a third change degree between the second target video and the third target video.

3. The method of claim 1, wherein the changing includes:
determining whether at least one of the change degrees exceeds a change degree threshold; and
when it is determined that all of the change degrees do not exceed the change degree threshold, changing the shooting cycle of the target from the first shooting cycle to the second shooting cycle, and
wherein the second shooting cycle has a greater value than the first shooting cycle.

4. The method of claim 3, wherein the changing the shooting cycle of the target from the first shooting cycle to the second shooting cycle includes:
determining a shooting cycle increase-decrease coefficient based on a difference between an average of a first change degree between the first target video and a second target video, a second change degree between the first target video and a third target video, and a third change degree between the second target video and the third target video and the change degree threshold; and
changing the shooting cycle of the target from the first shooting cycle to the second shooting cycle based on the shooting cycle increase-decrease coefficient.

5. The method of claim 1, further comprising determining whether to shoot the target at a second mission time point that is a mission time point after a first mission time point of obtaining the first target video,
wherein the determining includes determining whether to shoot the target at the second mission time point based on a number difference of days between the first mission time point and the second mission time point and the second shooting cycle.

6. The method of claim 5, further comprising, after shooting the target at the second mission time point, when at least one of the change degrees between the first target video and the target videos obtained before obtaining the first target video is greater than a change degree threshold, changing the shooting cycle of the target to a third shooting cycle,
wherein the third shooting cycle corresponds to a shooting cycle of shooting the target at every mission time point.

7. The method of claim 1, wherein the changing the shooting cycle of the target includes:
determining whether at least one of the change degrees exceeds a change degree threshold; and
when it is determined that at least one of the change degrees exceeds the change degree threshold, changing the shooting cycle of the target from the first shooting cycle to a third shooting cycle.

8. The method of claim 1, further comprising, when it is determined that the target is a new target, extracting a characteristic of the new target, determining a maximum shooting cycle related to the new target, registering target information of the new target, and determining a shooting cycle of the new target as a third shooting cycle.

9. An electronic apparatus that performs a method of changing a target shooting cycle, the electronic apparatus comprising:
a memory; and
a processor configured to obtain a first target video and detect a target included in the first target video through coordinate correction to the first target video, determine whether the target is a previously identified target, when it is determined that the target is the previously identified target, extract change degrees between the first target video and target videos obtained before obtaining the first target video, and change a shooting cycle of the target from a first shooting cycle to a second shooting cycle based on the change degrees.

10. A non-transitory computer-readable recording medium having a program for executing a method of changing a target shooting cycle on a computer, wherein the method includes:
obtaining a first target video and detecting a target included in the first target video through coordinate correction to the first target video;
determining whether the target is a previously identified target;
when it is determined that the target is the previously identified target, extracting change degrees between the first target video and target videos obtained before obtaining the first target video; and
changing a shooting cycle of the target from a first shooting cycle to a second shooting cycle based on the change degrees.
